(19) United States
(12) Patent Application Publication
(10) Pub. No.: US 2010/0002568 A1
(43) Pub. Date: Jan. 7, 2010

(54) High-density information storage apparatus

(76) Inventors: Jau-Jiu Ju, Hsinchu (TW); Hai-Hsiang Tsai, Hsinchu (TW); Tzuan-Ren Jeng, Hsinchu (TW); Der-Ray Huang, Hsinchu (TW); Feng-Hsiang Lo, Hsinchu (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/458,591

(22) Filed: Jul. 16, 2009

Related U.S. Application Data
(63) Continuation-in-part of application No. 10/263,188, filed on Oct. 3, 2002.

(30) Foreign Application Priority Data
May 21, 2002 (TW) 091110592

(51) Int. Cl. G11B 7/24

(52) U.S. Cl. 369/275.4; G9B/7

(57) ABSTRACT

A system is provided. The system includes an information storage medium including a substrate and a plurality of pit trains formed on the substrate at a track pitch between 0.64 and 0.67 micrometers. The system further includes a pickup head having a numerical aperture of around 0.6 and a wavelength of around 650 nanometers. The system has a tangential tilt margin between 0.54 and 0.68 degrees, and a radial tilt margin between 0.68 and 0.83 degrees when a jitter of the system is about 10%.

### BENEFIT CLAIMS

The present application is a continuation-in-part of, U.S. Non-Provisional application Ser. No. 10/263,188, filed on Oct. 3, 2002, entitled “High-Density Information Storage Medium”, which claims the right of priority based on Taiwanese Application No. 091110592 filed on May 21, 2002, the entire contents of both applications being incorporated herein by reference.

### TECHNICAL FIELD

Embodiments disclosed herein generally relate to a high-density information storage system, and particularly relate to an information storage system that has a shorter length of information bits and a smaller pitch of track.

### BACKGROUND

As the era of information and multi-media comes, the needs for high density and high volume storage media in triple-C (computer, communication and consumer electronics) products are increasing. Among the optical information storage media, the compact disc (CD) standard published by Philips and Sony in 1982 has been widely adopted and used today.

The requirements of high density and high volume storage media for multi-media applications today are getting higher and higher that prior CDs cannot meet. Though a popular video compact disc (VCD) can store video image, it is short in poorer video quality than video tape and low capacity of only one hour length of video that cannot afford a general film that has a length of at least 90 minutes. This makes video storage using more discs and inconvenience in changing the discs when viewing.

In order to improve the video quality and storage capacity, Philips, Sony and other manufacturers proposed the DVD (digital versatile disc) standard in April, 1996. For storing digital information, A DVD can afford 4.7 gigabytes that is much higher than the 650 megabytes of a compact disc. A DVD not only provides high quality sound and images but also has the capability of storing a video of approximately 133 minutes. Therefore, devices for reading and playing DVDs become the mainstream products in the consumer market. Variant DVD specifications have also been developed. In U.S. Pat. No. 5,777,981 owned by Toshiba, the track pitch of a DVD is set within the range of (0.72 to 0.8) times (λ/NA)/1.4 micrometer. When the wavelength of the light beam is 650 nanometer and the numerical aperture NA of the objective lens is 0.6, the track pitch is from 0.68 to 0.76 micrometer. This range just covers the wavelength 0.74 micrometer listed in the DVD specifications published by the DVD Forum (an international organization composed of hardware manufacturers for developing DVD-RW, DVD-R and DVD-RAM).

However, as the current video techniques being improved by high-definition television (HDTV) for the sake of higher video quality, the HDTV is becoming a new standard for high quality sound and image of video signal. The HDTV supports 1,920 times 1,080 resolution, 16:9 screen proportion and a higher refreshing frequency of 30 or 60 frames per second (while the current video frequency is only 24 or 30 frames per second). For the requirements of HDTV, the storage capacity of current 4.7 gigabyte DVD is further a bottleneck. A DVD media will now store only less than 40 minutes of HDTV signal. Therefore, the current DVD media cannot fulfill the need of HDTV video storage.

### BRIEF SUMMARY

In accordance with some embodiments, there is provided a system. The system includes an information storage medium including a substrate, a plurality of pit trains formed on the substrate at a track pitch between 0.64 and 0.67 micrometers. The system further includes a pickup head having a numerical aperture of around 0.6 and a wavelength of around 650 nanometers. The system has a tangential tilt margin between 0.54 and 0.68 degrees, and a radial tilt margin between 0.68 and 0.83 degrees when a jitter of the system is about 10%.

In accordance with some embodiments, there is provided a system. The system includes an information storage medium including a substrate, a plurality of pit trains formed on the substrate at a track pitch between 0.64 and 0.67 micrometers. The system further includes a pickup head having a numerical aperture of around 0.6 and a wavelength of around 650 nanometers, and a tilt servo controller. The system has a radial tilt margin between 0.95 and 1.16 degrees when a jitter of the system is about 10%.

In accordance with some embodiments, there is also provided a system. The system includes an information storage medium including a substrate, a plurality of pit trains formed on the substrate at a track pitch between 0.64 and 0.67 micrometers. The system further includes a pickup head having a numerical aperture of around 0.6 and a wavelength of around 650 nanometers. The system has a tangential tilt margin between 0.40 and 0.54 degrees, and a radial tilt margin between 0.50 and 0.67 degrees when a jitter of the system is about 9%.

In accordance with some embodiments, there is further provided a system. The system includes an information storage medium including a substrate, a plurality of pit trains formed on the substrate at a track pitch between 0.64 and 0.67 micrometers. The system further includes a pickup head having a numerical aperture of around 0.6 and a wavelength of around 650 nanometers, and a tilt servo controller. The system has a radial tilt margin between 0.70 and 0.94 degrees when a jitter of the system is about 9%.

Additional features and advantages of the embodiments disclosed herein will be set forth in part in the description which follows. The features and advantages of the disclosed embodiments will be realized and attained by means of the elements and combinations particularly pointed out in the appended claims.

It is to be understood that both the foregoing general description and the following detailed description are exemplary and explanatory only and are not restrictive.

The accompanying drawings, which are incorporated in and constitute a part of this specification, illustrate several embodiments and together with the description, serve to explain principles of some embodiments disclosed herein.

### BRIEF DESCRIPTION OF THE DRAWINGS

FIG. 1 is a descriptive view of a high-density information storage medium according to some embodiments;

FIG. 2 is a descriptive view of track and pit segments in a high-density information storage medium according to some embodiments;

FIG. 3A is a microscopic photograph of pit segments on a high-density information storage medium according to some embodiments;

FIG. 3B is a microscopic photograph of pit segments on a general DVD medium;

FIG. 4 is an eye-pattern of a high-density information storage medium according to some embodiments;

FIG. 5 is an eye-pattern of a general DVD medium;

FIG. 6A is an eye-pattern photograph of data read by a DVD pickup head for a high-density information storage medium according to some embodiments;

FIG. 6B is an eye-pattern photograph of data read by a DVD pickup head for a general DVD medium;

FIG. 7 is a comparative diagram on levels of radio frequency signals of a high-density information storage medium according to some embodiments and a general DVD medium;

FIG. 8A is a jitter versus tangential tilt margin diagram for a system according to some embodiments;

FIG. 8B is a jitter versus radial tilt margin diagram for a system according to some embodiments;

FIG. 9 is a jitter versus radial tilt margin diagram for a system with a tilt servo controller according to some embodiments;

FIG. 10 is a diagram illustrating a system including a servo controller, according to some embodiments.

### DETAILED DESCRIPTION OF THE DISCLOSED EMBODIMENTS

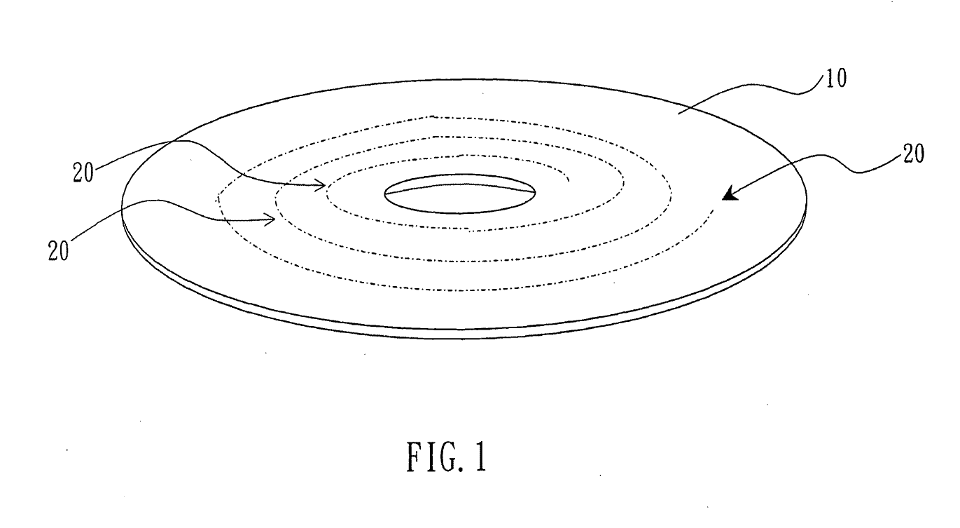

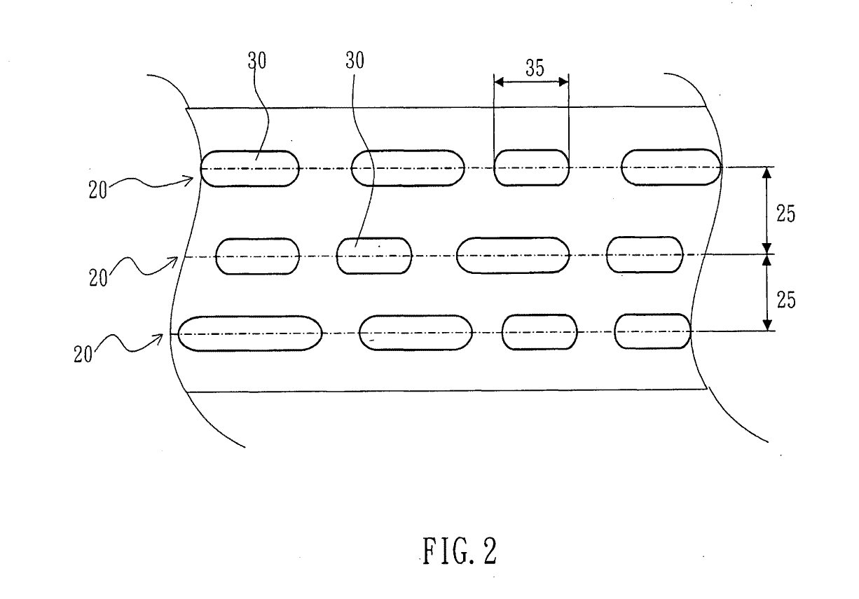

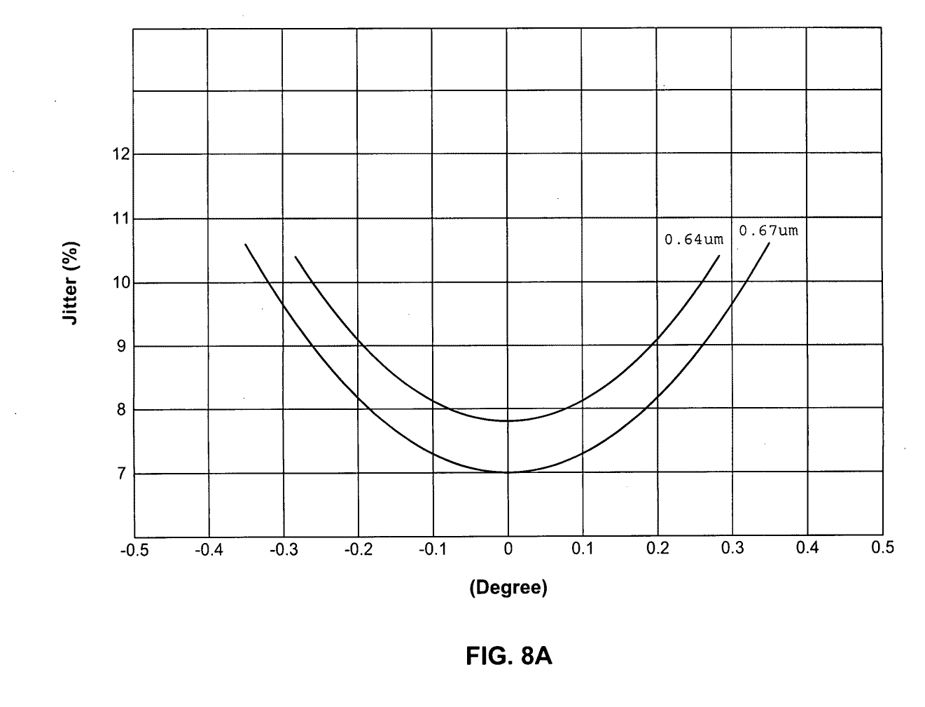

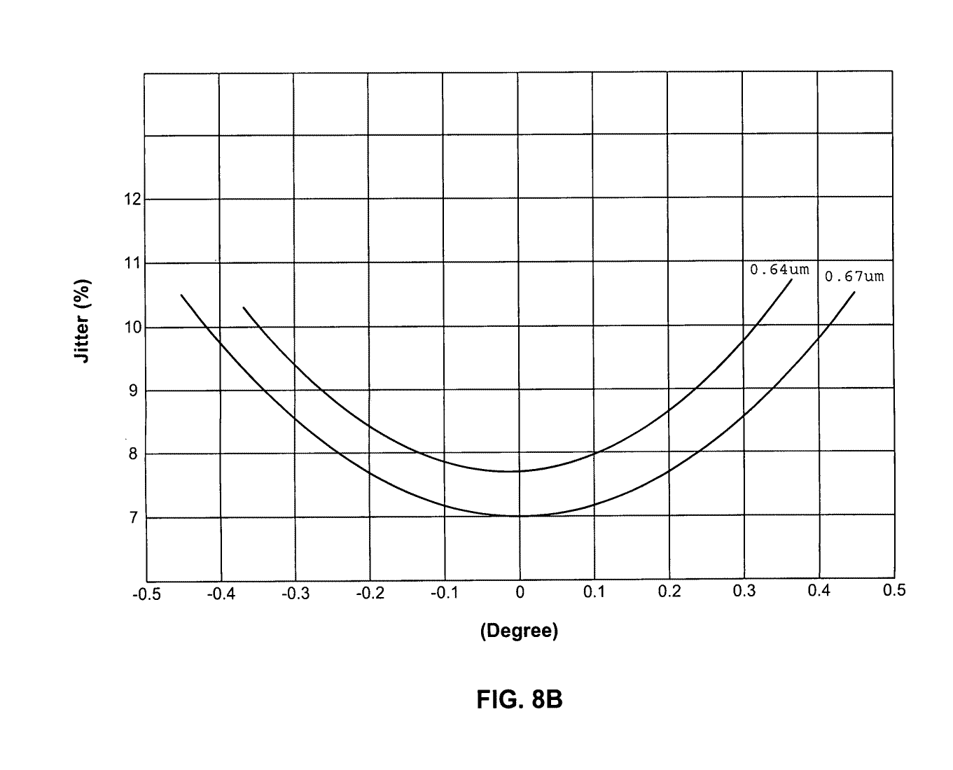

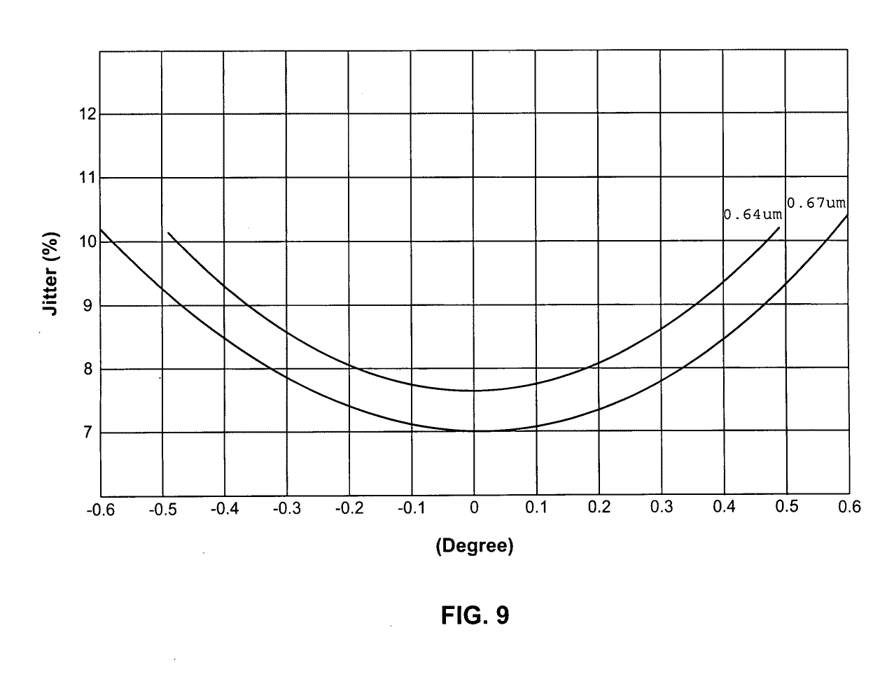

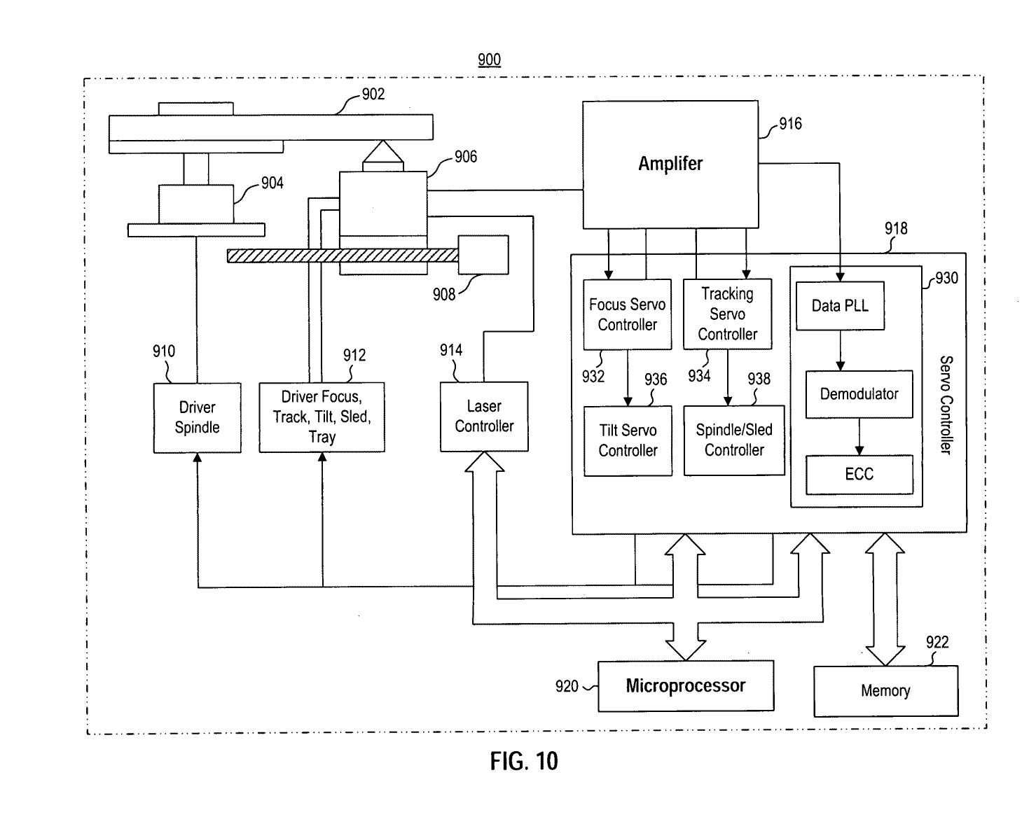

According to some embodiments, a system, such as system 900 shown in FIG. 10, is provided including an information storage medium having a higher storage density than a general DVD medium. A general DVD medium has a diameter of 120 millimeters and a storage capacity of 4.7 gigabytes for a single-side single-layer disc. The track pitch is 0.74 micrometers. The minimum pit length is 0.4 micrometers and the data bit length is 0.267 micrometers. The wavelength of the light beam of pickup head is 650 nanometers and the numerical aperture (NA) of the objective lens is 0.6. As shown in FIG. 1 and FIG. 2, a high-density information storage medium has a same configuration of diameter and thickness as a general DVD medium. A medium according to some embodiments includes a substrate 10 having information recorded by a plurality of pit trains 20 formed thereon at a specified track pitch 25. The track pitch 25 is set around 0.64 micrometers. A minimum length 35 of the signal pit 30 is around 0.4 micrometers. By further applying high-efficiency recording techniques, such as 8/15 modulation, the data bit length can further be shortened to 0.25 micrometers. An error correction code can also be adopted. The system according to some embodiments as described above may achieve a tangential tilt margin between about 0.54 and 0.68 degrees, and a radial tilt margin between about 0.68 and 0.83 degrees when a jitter of the system is about 10%. A more detailed description of tilt margin will be given below with respect to FIGS. 8A, 8B, and 9.

FIG. 10 is a diagram illustrating a system including a servo controller, according to some embodiments. As shown in FIG. 10, system 900 includes: a high-density information storage disc 902, a spindle 904 for holding the high-density information storage disc 902, a pick-up head 906, a sled motor 908 for moving the pick-up head 906, a spindle driver section 910, a driver section 912, which provides a driving force for focus, track, tilt, sled, and tray control. Consistent with some embodiments, pick-up head 906 may have a numerical aperture of around 0.6 and be tuned to receive light at a wavelength of around 650 nanometers. System 900 further includes a laser controller 914 coupled to pick-up head 906 for controlling laser output in pick-up head 906. System 900 further includes an amplifier 916, a servo controller 918, a microprocessor 920, and a memory device 922. As shown in FIG. 10, servo controller 918 includes a reading section 930 which includes a data phase-locked loop (PLL), a demodulator, and an error correction code (ECC) section. Servo controller 918 further includes a focus servo controller 932, a tracking servo controller 934, a tilt servo controller 936, and a spindle/sled controller 938.

In operation, spindle 904 is set to rotate high-density information storage disc 902. Pick-up head 906 is set to read data from disc 902 and outputs the data to servo controller 918 through amplifier 916. Pick-up head 906 also outputs system control information including focus error signals, tracking error signals, tilt error signals, and spindle/sled control signals. After receiving the data and system control information from pick-up head 906, servo controller 918 coordinates with microprocessor 920 and memory device 922 to decode information stored in the disc 902 and to provide feed back control to spindle 904 and pick-up head 906.

Data read from disc 902 may include radio-frequency signals. In the servo controller 918, read section 930 may process the radio-frequency signals through the data PLL for demodulating the radio-frequency signals. After that, an error correction code process by the ECC section may be performed to restore the digital data recorded in disc 902.

After system control information is received in servo controller 918, it is processed by the controllers 932, 934, 936, 938 therein. For example, tilt servo controller 936 receives and processes the tilt error signals from pick-up head 906 to provide control signals to drive the tilt driver in driver section 912. With tilt servo controller 936, system 900 may have rather large tilt margin. Focus servo controller 932 receives and processes the focus error signals from pick-up head 906 to provide control signals to drive the focus driver in driver section 912. Tracking servo controller 934 receives and processes the tracking error signals from pick-up head 906 to provide control signals to drive the track driver in driver section 912. Further, spindle/sled controller 938 receives and processes the spindle/sled control signals from pick-up head 906 to provide control signals to drive the spindle driver 910 and the sled driver in driver section 912.

FIGS. 8A and 8B respectively show a tangential tilt margin and a radial tilt margin of a system, such as system 900, according to some embodiments disclosed herein. With reference to FIGS. 8A and 8B, when a track pitch is set between 0.64 and 0.67 micrometers, a system according to some embodiments may have a tangential tilt margin between 0.54 and 0.68 degrees, and a radial tilt margin between 0.68 and 0.83 degrees when a jitter of the system is about 10%. Further, a system according to some embodiments may have a tangential tilt margin between 0.40 and 0.54 degrees, and a radial tilt margin between 0.50 and 0.67 degrees when a jitter of the system is about 9%. Further, a system according to some embodiments may have a tangential tilt margin between 0.17 and 0.37 degrees, and a radial tilt margin between 0.24 and 0.46 degrees when a jitter of the system is about 8%.

A system, such as system 900 shown in FIG. 10, according to some embodiments may further include a tilt servo controller, such as tilt servo controller 936, for improving tilt margin of the system. With reference to FIG. 9, a radial tilt margin of a system equipped with a tilt servo controller may be between 0.95 and 1.16 degrees when a jitter of the system is about 10%. In another embodiment, a radial tilt margin of a system equipped with a tilt servo controller may be between 0.70 and 0.94 degrees when a jitter of the system is about 9%. In another embodiment, a radial tilt margin of a system equipped with a tilt servo controller may be between 0.37 and 0.64 degrees when a jitter of the system is about 8%.

A tilt margin may be defined as an angle below which a datum recorded on an information storage medium may be readable in a system. A tangential tilt margin may be obtained from measuring a tilt margin from the tangential direction of a disc, and a radial tilt margin may be obtained from measuring a tilt margin from the radial direction of a disc.

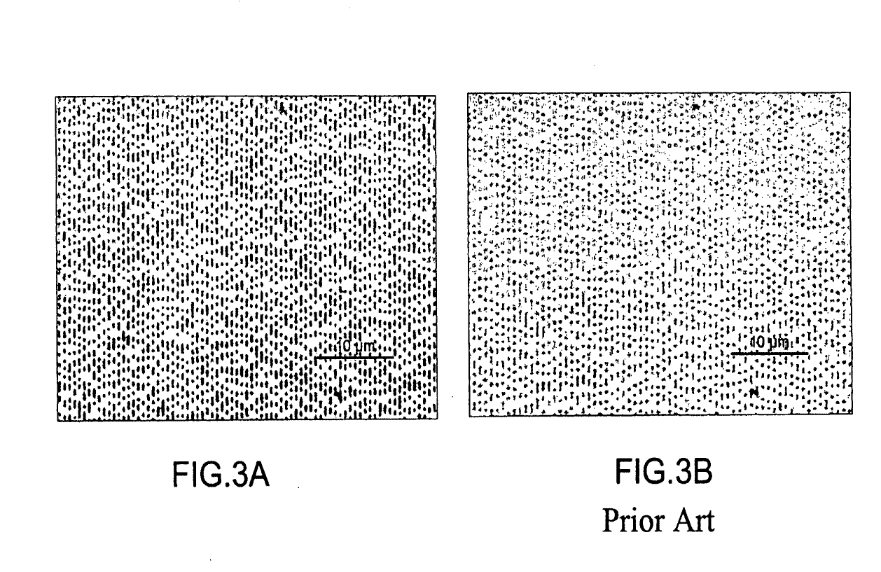

FIG. 3A is a microscopic photograph of pit segments on a high-density information storage medium according to some embodiments. In comparison with FIG. 3B, which is a microscopic photograph of pit segments on a general DVD medium, it is clear that a high-density information storage medium according to some embodiments has a higher storage density than the general DVD medium.

The high-density information storage medium according to some embodiments may be made under the current CD fabrication process and facilities so as to lessen the cost influence. Also, the high-density information storage medium according to some embodiments may be compatible with current DVD hardware that prior DVD pickup heads with 650 nanometer light beam and 0.6 numerical aperture can be used to read the information stored on the new medium. Therefore, it will not increase cost of new devices to the customers.

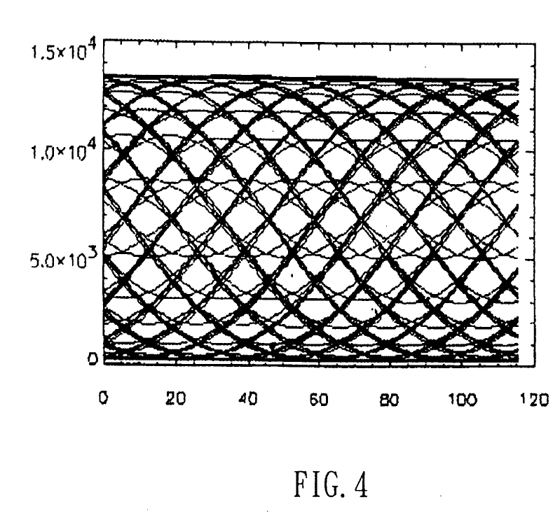

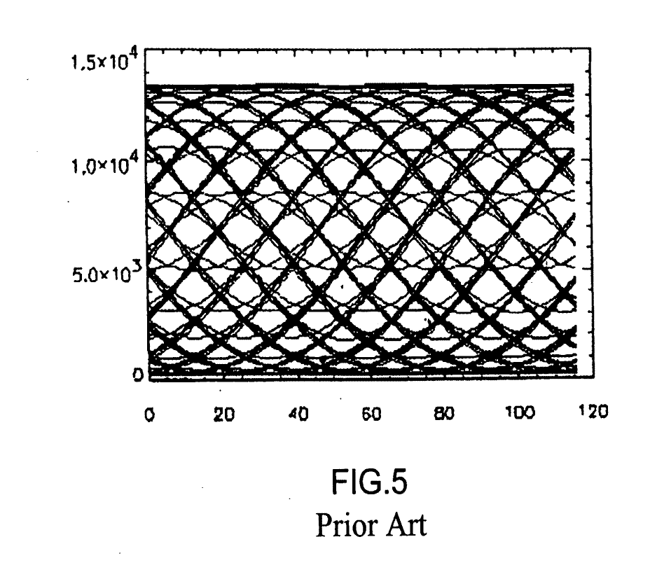

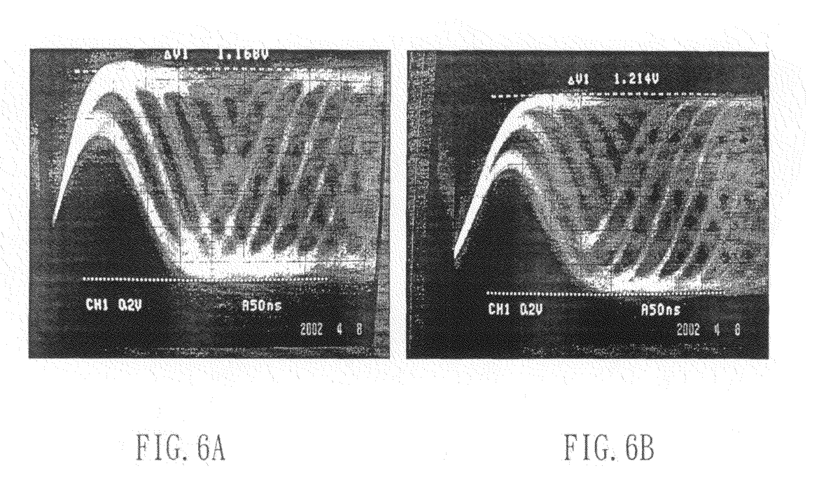

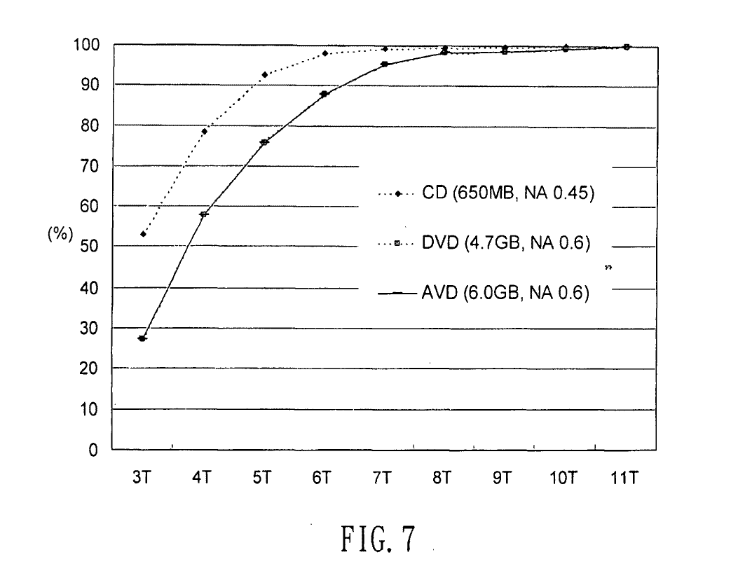

FIG. 4 is an eye-pattern of a high-density information storage medium of the invention. Eye-pattern is the received waveform of the read back signal from the disc. The horizontal axis is a time scale, while the vertical axis is the amplitude of read signal. The eye patterns are used by those skilled in the art to judge the quality of the read back signal. In comparison with FIG. 5, an eye-pattern of a general DVD medium, they have the similar patterns. Further comparing the photographs taken directly from oscilloscope for eye-patterns of a high-density information storage medium of the invention and a general DVD, as shown in FIGS. 6A and 6B, they show the similar patterns. Also, from FIG. 7, a comparison chart of radio-frequency (RF) signal levels among a compact disc, a general DVD and a high-density information storage medium according to some embodiments, it is clear that the medium according to embodiments disclosed herein has a same RF signal level as the general DVD. By the aforesaid comparisons, it is sure that the signal qualities of the high-density information storage medium according to embodiments disclosed herein and the general DVD medium are comparable, and the high-density information storage medium according to some embodiments can be read back with current DVD devices.

In practice, the track pith of a high-density information storage medium according to some embodiments may be set in a range of 0.61 to 0.67 micrometers. The minimum pit length is set in a range of 0.28 to 0.47 micrometers. The diameter of the medium is 80 or 120 millimeters with a variance less than 5%. By applying multi-layer and double-side techniques, a high-density information storage medium according to some embodiments may also be made as a single-side multi-layer disc, a double-side single-layer disc or a double-side multi-layer disc.

In conclusion, embodiments disclosed herein increase the storage capacity of an information storage medium by shortening the track pitch and data bit length and increasing the storage density. The medium according to some embodiments can be made by current CD manufacturing facilities, and can be read through general DVD devices. By applying 8/15 modulation and high-efficiency error correction code (ECC) methods, the storage capacity of a single-side single-layer disc medium can be increased to 6 gigabytes. By further applying multi-layer and double-side techniques, a single-side double-layer disc can store about 11 gigabytes; a double-side single-layer disc can store about 12 gigabytes; and a double-side double-layer disc can store about 22 gigabytes. Table 1 lists the specifications and capacities of general DVD and single and multi-layer media according to some embodiments for reference.

TABLE 1

| | General DVD | | High-density medium of the invention | | | |
|---|---|---|---|---|---|---|
| | 1-side | 1-side | 1-side | 1-side | 2-side | 2-side |
| Parameters | 1-layer | 2-layer | 1-layer | 2-layer | 1-layer | 2-layer |
| Numerical aperture | 0.6 | 0.6 | 0.6 | 0.6 | 0.6 | 0.6 |
| Beam wavelength (nm) | 650 | 650 | 650 | 650 | 650 | 650 |
| Track pitch (μm) | 0.74 | 0.74 | 0.64 | 0.64 | 0.64 | 0.64 |
| Data bit length (μm) | 0.267 | 0.293 | 0.250 | 0.275 | 0.250 | 0.275 |
| Minimum pit length (μm) | 0.40 | 0.44 | 0.40 | 0.44 | 0.40 | 0.44 |
| Disc Diameter (mm) | 120 | 120 | 120 | 120 | 120 | 120 |
| Substrate thickness (mm) | 1.2 | 1.2 | 1.2 | 1.2 | 1.2 | 1.2 |
| Storage capacity (GB) | 4.7 | 8.5 | 6.0 | 11.0 | 12.0 | 22.0 |

Furthermore, when applying information compression techniques, such as MPEG-4, the storage capacity for motion pictures can further be increased. Therefore, the high-density information storage medium is practical under current manufacturer facilities and customer devices. It is easy to be accepted by the manufacturers and customers.

Variations of the disclosed embodiments are not to be regarded as a departure from the disclosed embodiments, and all such modifications as would be obvious to one skilled in the art are intended to be included within the scope of the following claims.

What is claimed is:

1. A system, comprising:
an information storage medium including a substrate, a plurality of pit trains formed on the substrate at a track pitch between 0.64 and 0.67 micrometers; and
a pickup head having a numerical aperture of around 0.6 and a wavelength of around 650 nanometers,
wherein the system has a tangential tilt margin between 0.54 and 0.68 degrees, and a radial tilt margin between 0.68 and 0.83 degrees when a jitter of the system is about 10%.

2. The system as clamed in claim 1, wherein the pit trains include a signal pit having a length around 0.4 micrometers.

3. The system as clamed in claim 2, wherein the pit trains are configured such that a data bit length is about 0.25 micrometers in combination with an eight to fifteen (8/15) modulation.

4. The system as clamed in claim 3, wherein the system is configured with error correction codes.

5. The system as clamed in claim 1, wherein the pit trains formed on said substrate provide a six-gigabyte storage capacity with a single-side single-layer configuration.

6. The system as claimed in claim 1, wherein the information storage medium includes a recording layer.

7. A system, comprising:
an information storage medium including a substrate, a plurality of pit trains formed on the substrate at a track pitch between 0.64 and 0.67 micrometers;
a pickup head having a numerical aperture of around 0.6 and a wavelength of around 650 nanometers; and
a tilt servo controller,
wherein the system has a radial tilt margin between 0.95 and 1.16 degrees when a jitter of the system is about 10%.

8. A system, comprising:
an information storage medium including a substrate, a plurality of pit trains formed on the substrate at a track pitch between 0.64 and 0.67 micrometers; and
a pickup head having a numerical aperture of around 0.6 and a wavelength of around 650 nanometers,
wherein the system has a tangential tilt margin between 0.40 and 0.54 degrees, and a radial tilt margin between 0.50 and 0.67 degrees when a jitter of the system is about 9%.

9. The system as claimed in claim 8, wherein the pit trains include a signal pit having a length around 0.4 micrometers.

10. The system as clamed in claim 9, wherein the pit trains are configured such that a data bit length is about 0.25 micrometers in combination with an eight to fifteen (8/15) modulation.

11. The system as clamed in claim 10, wherein the system is configured with error correction codes.

12. The system as clamed in claim 8, wherein the pit trains formed on said substrate provide a six-gigabyte storage capacity with a single-side single-layer configuration.

13. The system as clamed in claim 8, wherein the information storage medium includes a recording layer.

14. A system, comprising:
an information storage medium including a substrate, a plurality of pit trains formed on the substrate at a track pitch between 0.64 and 0.67 micrometers;
a pickup head having a numerical aperture of around 0.6 and a wavelength of around 650 nanometers; and
a tilt servo controller,
wherein the system has a radial tilt margin between 0.70 and 0.94 degrees when a jitter of the system is about 9%.
